(19) United States
(12) Patent Application Publication
(10) Pub. No.: US 2026/0367544 A1
(43) Pub. Date: Nov. 19, 2026

(54) IMAGE FORMING APPARATUS

(71) Applicant: KYOCERA Document Solutions Inc., Osaka (JP)

(72) Inventor: An Van NGUYEN, Osaka (JP)

(73) Assignee: KYOCERA Document Solutions Inc., Osaka (JP)

(21) Appl. No.: 19/669,248

(22) Filed: May 6, 2026

(30) Foreign Application Priority Data
May 15, 2025 (JP) 2025-082100

(51) Int. Cl. G03G 15/01; G03G 15/16

(52) U.S. Cl. CPC G03G 15/0189; G03G 15/0131; G03G 15/1605; G03G 2215/0129

(57) ABSTRACT

An image forming apparatus includes a primary transfer roller, a conductive bushing, a spring contact, a fixed case, and an elastic member. The primary transfer roller is applied with a transfer bias for transferring a toner image from a photoconductive drum to an intermediate transfer belt. The conductive bushing supports an end portion of the primary transfer roller. The spring contact is electrically connected to the primary transfer roller via the conductive bushing. The fixed case houses the conductive bushing and the spring contact. The elastic member applies a load to the primary transfer roller from a direction parallel to a load direction of the spring contact.

### INCORPORATION BY REFERENCE

This application is based on and claims the benefit of priority from Japanese patent application No. 2025-082100 filed on May 15, 2025 which is incorporated by reference in its entirety.

### BACKGROUND

The present disclosure relates to an image forming apparatus including a primary transfer roller to which a transfer bias for transferring a toner image from an intermediate transfer belt to a photoconductive drum is applied.

In a full-color image forming apparatus, it is common to have a tandem configuration in which photoconductive drums provided for colors of toner are arranged along a traveling direction of an endless intermediate transfer belt, a toner image of each color is sequentially primarily transferred from each photoconductive drum to the intermediate transfer belt to form a full-color toner image, and the full-color toner image is secondarily transferred to a sheet. When the toner image is transferred from each photoconductive drum to the intermediate transfer belt, a high-voltage transfer bias is applied from a transfer bias power source to a primary transfer roller which is disposed inside the intermediate transfer belt so as to face the photoconductive drum. The transfer bias is applied to the primary transfer roller via a spring contact.

### SUMMARY

An image forming apparatus according to the present disclosure includes a primary transfer roller, a conductive bushing, a spring contact, a fixed case, and an elastic member. The primary transfer roller is applied with a transfer bias for transferring a toner image from a photoconductive drum to an intermediate transfer belt. The conductive bushing supports an end portion of the primary transfer roller. The spring contact is electrically connected to the primary transfer roller via the conductive bushing. The fixed case houses the conductive bushing and the spring contact. The elastic member applies a load to the primary transfer roller from a direction parallel to a load direction of the spring contact.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a view schematically showing an inside of an image forming apparatus according to one embodiment of the present disclosure.

FIG. 2 is a perspective view showing four primary transfer rollers supported by front and rear rails via front and rear bearing assemblies, in the image forming apparatus according to the embodiment of the present disclosure.

FIG. 3 is a cross-sectional view showing the primary transfer roller supported by the front and rear bearing assemblies, in the image forming apparatus according to the embodiment of the present disclosure.

FIG. 4 is a perspective view showing the rear bearing assembly, in the image forming apparatus according to the embodiment of the present disclosure.

FIG. 5A is a perspective view showing a fixed case of the rear bearing assembly, in the image forming apparatus according to the embodiment of the present disclosure.

FIG. 5B is a perspective view showing the fixed case of the rear bearing assembly, in the image forming apparatus according to the embodiment of the present disclosure.

FIG. 6 is a perspective view showing a conductive bushing of the rear bearing assembly, in the image forming apparatus according to the embodiment of the present disclosure.

FIG. 7A is a perspective view showing an intermediate case of the rear bearing assembly, in the imaging apparatus according to the embodiment of the present disclosure.

FIG. 7B is a perspective view of the intermediate case of the rear bearing assembly, in the imaging apparatus according to the embodiment of the present disclosure.

FIG. 8 is a perspective view showing the conductive bushing, the intermediate case, an auxiliary coil spring, and a spring contact of the rear bearing assembly, in the image forming apparatus according to the embodiment of the present disclosure.

FIG. 9 is a view explaining a load applied to a primary transfer roller, in the image forming apparatus according to the embodiment of the present disclosure.

FIG. 10 is a disassembled perspective view showing the rear bearing assembly according to a modified example of the image forming apparatus according to the embodiment of the present disclosure.

FIG. 11 is a perspective view showing the rear bearing assembly according to the modified example of the image forming apparatus according to the embodiment of the present disclosure.

FIG. 12 is a view explaining a load applied to the primary transfer roller in the modified example of the image forming apparatus according to the embodiment of the present disclosure.

### DETAILED DESCRIPTION

Hereinafter, with reference to the drawings, an image forming apparatus according to one embodiment of the present disclosure will be described.

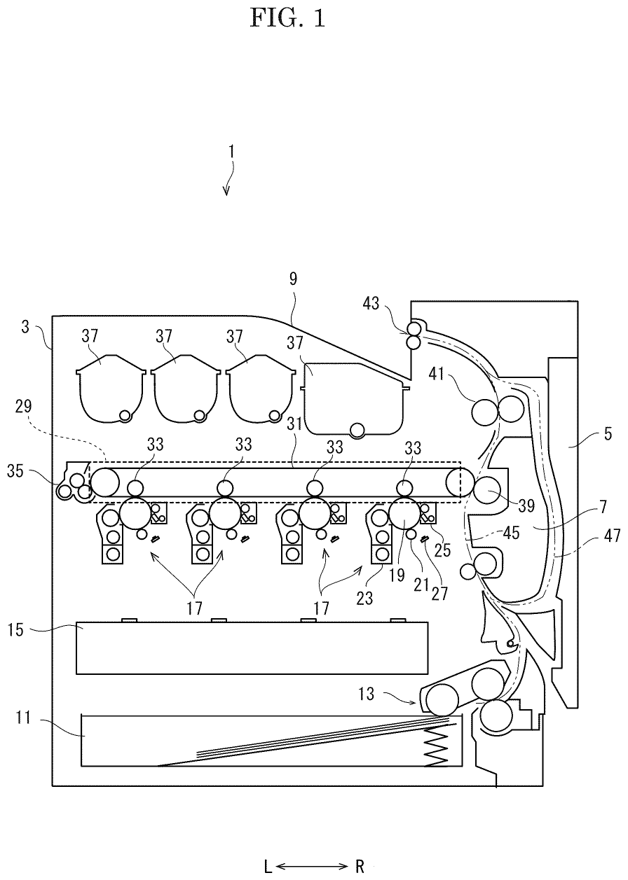

First, with reference to FIG. 1, the entire structure of the image forming apparatus 1 according to this embodiment will be described. FIG. 1 is a view schematically showing the inside of the image forming apparatus 1. In the following figures, Fr, Rr, L, and R indicate the front side, rear side, left side, and right side of the image forming apparatus 1, respectively.

The image forming apparatus 1 includes a box-shaped apparatus main body 3. An opening is formed on the right surface of the apparatus main body 3. The opening is opened and closed by an outer cover 5 supported by the apparatus main body 3 turnably around the lower end portion. On the inner side of the outer cover 5, a conveying unit 7 is supported by the apparatus main body turnably around the lower end portion. A sheet discharge tray 9 is formed on the top surface of the apparatus main body 3.

A sheet feeding cassette 11 in which a sheet is stored is detachably housed in the lower portion of the apparatus main body 3. A sheet feeding device 13 is provided on the rear side of the sheet feeding cassette 11. An exposure device 15 is provided above the sheet feeding cassette 11. Above the exposure device 15, four image forming units 17 corresponding to four colors (black, cyan, magenta and yellow) are arranged in parallel in the left-and-right direction.

Each image forming unit 17 includes a photoconductive drum 19, a charger 21, a developing device 23, a cleaning device 25, and a static eliminator 27. The photoconductive drum 19 is rotatably provided. The charger 21, the developing device 23, the cleaning device 25, and the static eliminator 27 are arranged around the photoconductive drum 19 in order.

An intermediate transfer unit 29 is housed above the four image forming units 17. The intermediate transfer unit 29 can be pulled out from the apparatus main body 3 through the opening. The intermediate transfer unit 29 includes an endless intermediate transfer belt 31 supported by the left and right rollers, four primary transfer rollers 33 arranged in parallel in the left-and-right direction in the space enclosed by the intermediate transfer belt 31, and a cleaning device 35 arranged outside the left end portion of the intermediate transfer belt 31. The four primary transfer rollers 33 face the photoconductive drums 19 of the four image forming units 17 across the intermediate transfer belt 31. A primary transfer nip is formed between the photoconductive drum 19 and the intermediate transfer belt 31.

Above the intermediate transfer unit 29, four toner containers 37 for supplying the toner of corresponding colors to the developing devices 23 of the four image forming units 17 are mounted.

A secondary transfer roller 39 is rotatably supported by the conveying unit 7 on the rear side of the intermediate transfer unit 29, and a secondary transfer nip is formed between the intermediate transfer belt 31 and the secondary transfer roller 39. A fixing device 41 is provided above the secondary transfer nip. A sheet discharge device 43 is provided above the fixing device 41.

The apparatus main body 3 is provided with a main conveying path 45 and an inversion conveying path 47. The main conveying path 45 extends from the sheet feeding device 13 to the sheet discharge device 43 through the secondary transfer nip and the fixing device 41. The inversion conveying path 47 branches rearward from the main conveying path 45 on the downstream side of the fixing device 41 and merges with the main conveying path 45 on the downstream side of the sheet feeding device 13.

Next, the image forming operation of the image forming apparatus 1 having such a configuration will be described. In each image forming unit 17, the surface of the photoconductive drum 19 is charged by the charger 21. Thereafter, the exposure device 15 irradiates the photoconductive drum 19 with a laser beam corresponding to image data to form an electrostatic latent image on the surface of the photoconductive drum 19. The electrostatic latent image is developed into a toner image of the corresponding color by the developing device 23. In the primary transfer nip, the toner image formed on the surface of the photoconductive drum 19 is primarily transferred to the surface of the intermediate transfer belt 31 by the primary transfer roller 33 to which a transfer bias having a polarity opposite to that of the toner is applied. A configuration for applying the transfer bias to the primary transfer roller 33 will be described later. When the four image forming units 17 perform the above operations, a full-color toner image is formed on the intermediate transfer belt 31. The toner and the charge remaining on the photoconductive drum 19 are removed by the cleaning device 25 and the static eliminator 27.

On the other hand, the sheet fed from the sheet feeding cassette 11 by the sheet feeding device 13 is conveyed to the secondary transfer nip along the main conveying path 45 in timing with the above-described image forming operation, and the full-color toner image on the intermediate transfer belt 31 is secondarily transferred to the sheet in the secondary transfer nip. The sheet to which the toner image is secondarily transferred is conveyed to the fixing device 41 along the main conveying path 45, and the toner image is fixed to the sheet in the fixing device 41. The sheet on which the toner image is fixed is discharged to the discharge tray 9 by the discharge device 43. When double-sided printing is performed, the sheet on which an image is formed on one side is conveyed from the inversion conveying path 47 to the main conveying path 45, and the image forming operation is similarly performed.

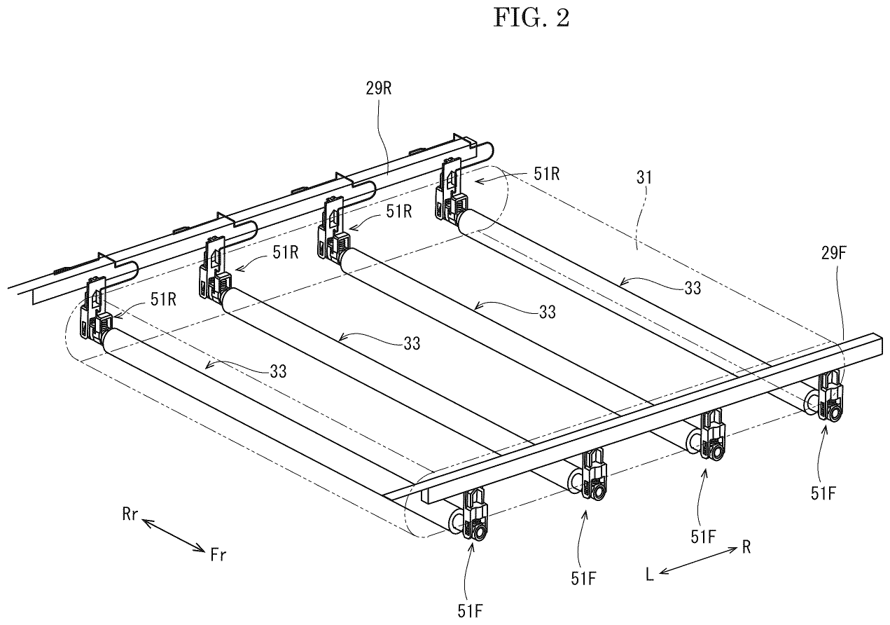

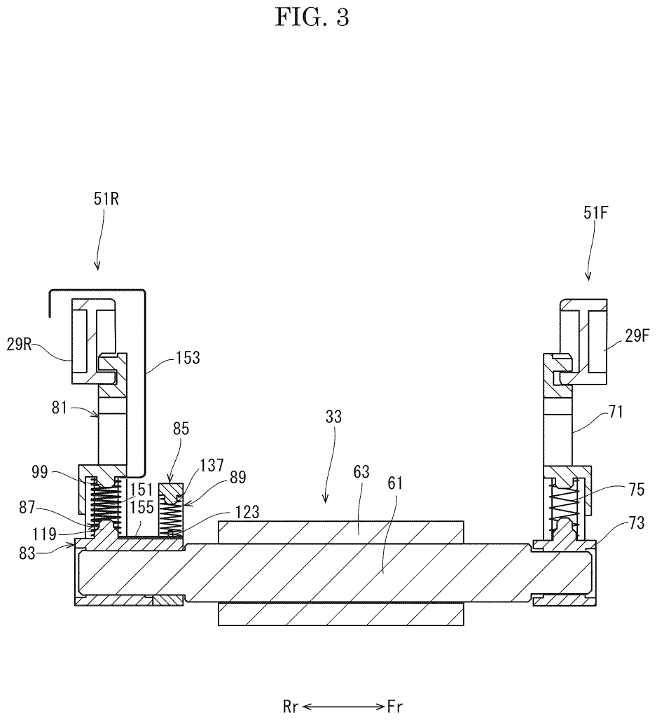

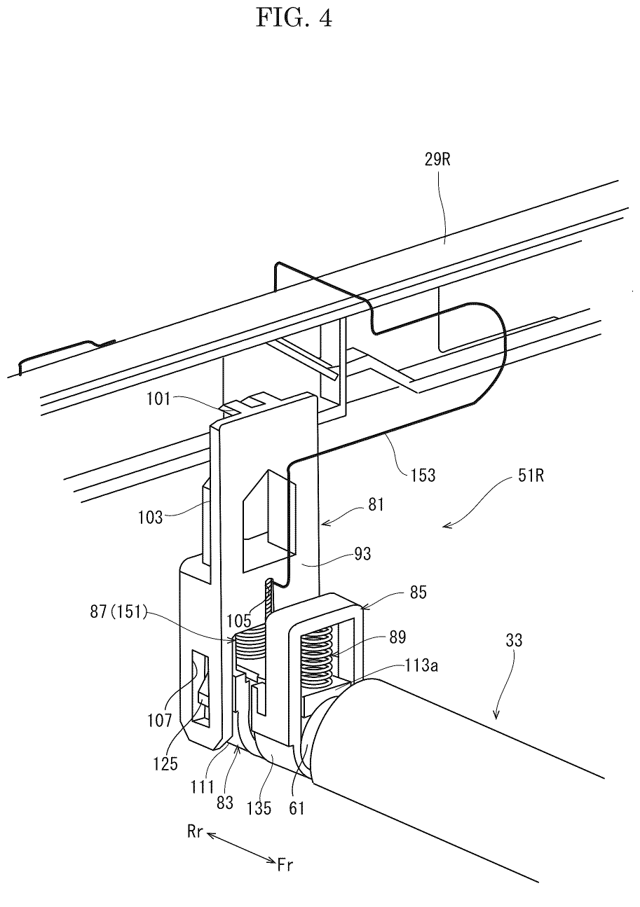

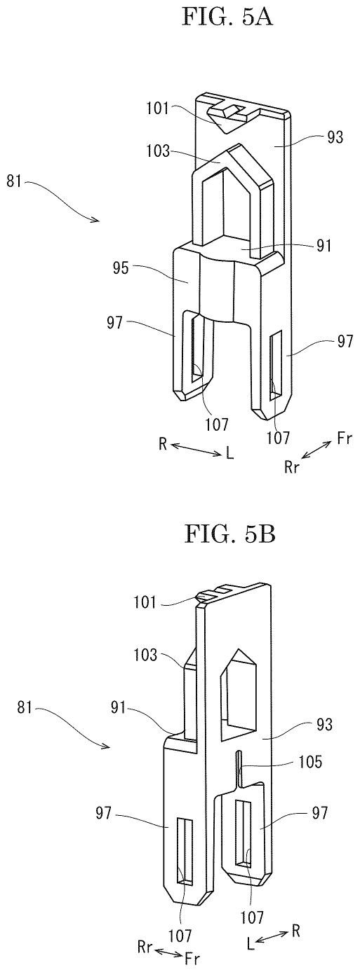

Next, the configuration in which a transfer bias is applied to the primary transfer roller 33 will be described with reference to FIG. 2 to FIG. 5. FIG. 2 and FIG. 3 are perspective views showing the primary transfer roller 33 supported by front and rear bearing assemblies 51F and 51R, FIG. 4 is a cross-sectional view showing the front and rear bearing assemblies 51F and 51R and the primary transfer roller 33, and FIG. 5 is a perspective view showing the rear bearing assembly 51R.

As shown in FIG. 2, the four primary transfer rollers 33 are supported between front and rear rails 29F and 29R provided in the intermediate transfer unit 29, and face the inner peripheral surface of the intermediate transfer belt 31 traveling on the lower track. More specifically, as also shown in FIG. 3, the front and rear end portions of the primary transfer rollers 33 are supported by the front and rear rails 29F and 29R via the front bearing assembly 51F and the rear bearing assembly 51R, respectively.

First, the primary transfer roller 33 will be described. As shown in FIG. 3, the primary transfer roller 33 has a conductive rotational shaft 61 and a roller body 63 made of elastic body having a predetermined resistance value. The front and rear end portions of the rotational shaft 61 are exposed from the roller body 63.

Next, the front bearing assembly 51F will be described with reference to FIG. 3. The front bearing assembly 51F includes a fixed case 71, a conductive bushing 73, and a compression coil spring 75, and rotatably supports the front end portion of the rotational shaft 61. A detailed description of the front bearing assembly 51F is omitted.

Next, the rear bearing assembly 51R will be described with reference to FIG. 3. The rear bearing assembly 51R rotatably supports the rear end portion of the rotational shaft 61 and electrically connects the rotational shaft 61 to a transfer bias power supply (not shown). The rear bearing assembly 51R includes a fixed case 81, a conductive bushing 83, an intermediate case 85, a spring contact 87, and an auxiliary coil spring 89.

First, the fixed case 81 will be described with reference to FIG. 5A and FIG. 5B. FIG. 5A and FIG. 5B are perspective views showing the fixed case 81. The fixed case 81 has a top plate part 91, a front plate part 93 and a rear plate part 95 facing each other, and a pair of leg parts 97 facing each other. The fixed case 81 is made of, for example, resin. The top plate part 91 has a long rectangular shape in a direction perpendicular to the axial direction of the primary transfer roller 33. The front plate part 93 and the rear plate part 95 face each other in the axial direction. The front plate part 93 and the rear plate part 95 are rectangular, the front plate part 93 is higher than the rear plate part 95, and the upper portion of the front plate part 93 projects upward from the top plate part 91. The pair of leg parts 97 face each other in a direction perpendicular to the axial direction, and extend below the front plate part 93 and the rear plate part 95.

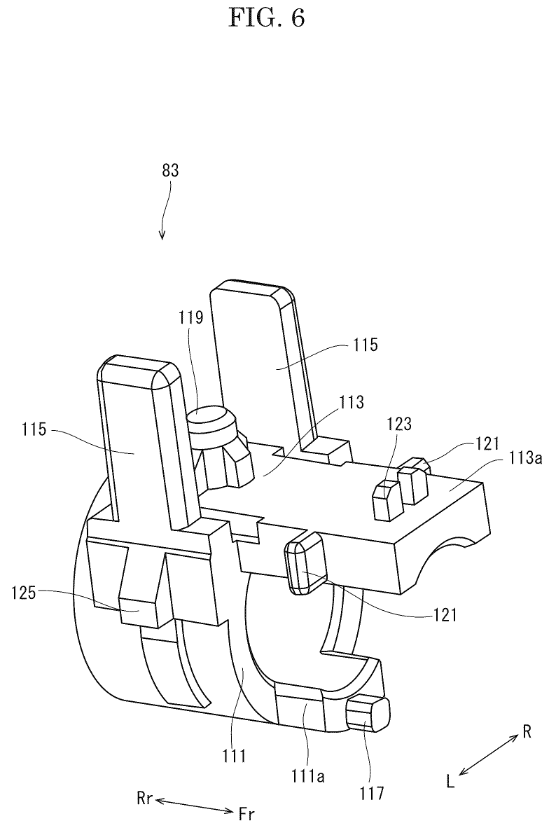

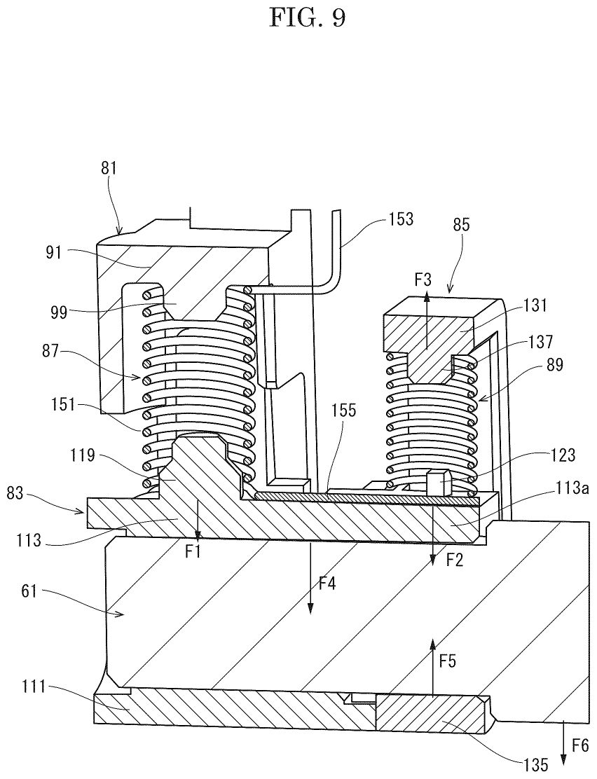

On the lower surface of the top plate part 91, a projection 99 (not shown in FIG. 6A and FIG. 6B, see FIG. 3 and FIG. 9) is formed. On the rear surface of the upper portion of the front plate part 93, upper and lower ribs 101 and 103 are formed. The upper rib 101 has a triangular shape whose top faces downward. The lower rib 103 has a pentagonal shape whose top faces upward. The tops of the upper and lower ribs 101 and 103 are opposed to each other in the upper-and-lower direction with a predetermined interval. In the lower portion of the front plate part 93, a slit 105 cut upward from the lower edge is formed. The pair of leg parts 97 have openings 107 extending in the upper-and-lower direction.

Next, the conductive bushing 83 will be described with reference to FIG. 6. FIG. 6 is a perspective view showing the conductive bushing 83. The conductive bushing 83 has a cylindrical bearing part 111 extending in the axial direction, a top plate part 113, and a pair of side plate parts 115. The conductive bushing 83 is made of conductive material such as metal. The bearing part 111 has an inner diameter equal to the diameter of the rotational shaft 61 of the primary transfer roller 33. Further, the bearing part 111 has an extension portion 111a (referred to as a bearing extension portion) projecting in the axial direction from the lower portion of the end surface. A guide pin 117 projecting in the axial direction is provided on the end surface of the bearing extension portion 111a.

The top plate part 113 is formed on the upper surface of the bearing part 111 and has a flat upper surface. A projection 119 is formed on the upper surface. Further, the top plate part 113 has an extension portion 113a (referred to as a top plate extension portion) projecting in the axial direction. The top plate extension portion 113a projects longer than the bearing extension portion 111a. Guide projections 121 extending in the upper-and-lower direction are formed on both side surfaces of the top plate extension portion 113a. Further, a pair of engagement projections 123 are formed on the upper surface of the top plate extension portion 113a in a direction perpendicular to the axial direction.

The pair of side plate parts 115 face each other in a direction perpendicular to the axial direction and extend upward more than the projection 119 from the side surfaces of the bearing part 111. Engagement projections 125 extending in the upper-and-lower direction are formed on the outer surfaces of the pair of side plate parts 115. The engagement projection 125 has a rectangular parallelepiped shape, and its upper surface is inclined downward.

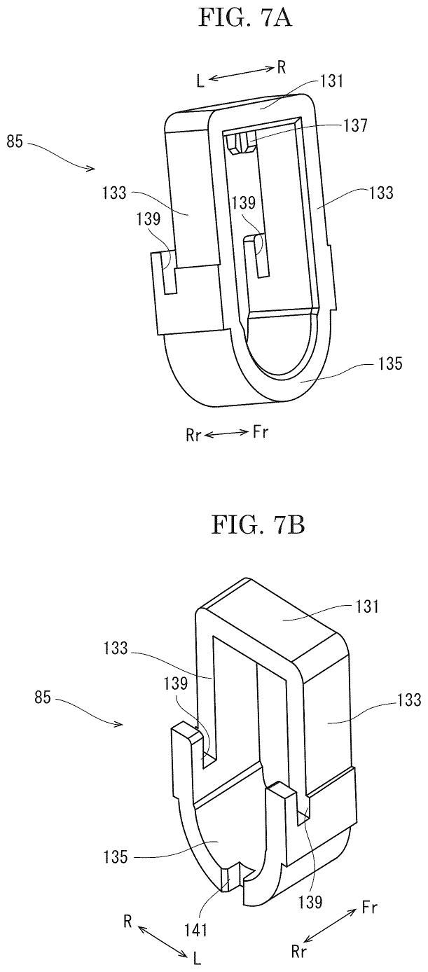

Next, the intermediate case 85 will be described with reference to FIG. 7A and FIG. 7B. FIG. 7A and FIG. 7B are perspective views showing the intermediate case 85. The intermediate case 85 is a cylindrical member having an opening penetrating in the axial direction, and has a top plate part 131, a pair of side plate parts 133, and a bottom plate part 135. The intermediate case 85 is made of conductive material such as metal. A projection 137 is formed on the lower surface of the top plate part 131. The lower portions of the pair of side plate parts 133 are formed to be longer in length (length along the axial direction) than the upper portions, and the lower portions project toward one side (rear side) in the axial direction than the upper portions. The projecting lower portion has a guide groove 139 cut downward in a direction perpendicular to the axial direction and along the upper-and-lower direction. The bottom plate part 135 is formed in a semicylindrical shape projecting downward. A guide groove 141 extending in the upper-and-lower direction is formed in one (rear) end surface of the bottom plate part 135.

Next, the spring contact 87 will be described with reference to FIG. 3 and FIG. 4. The spring contact 87 has a coiled deflection part 151, a fixed end part 153 extending from one end of the deflection part 151, and a free end part 155 extending from the other end of the deflection part 151. The free end part 155 extends radially linearly from the deflection part 151.

Next, the auxiliary coil spring 89 will be described. The auxiliary coil spring 89 is a metal coil spring, and is accommodated in the intermediate case 85. The auxiliary coil spring 89 is an example of the elastic member which applies a load to the primary transfer roller 33 from a direction parallel to the load direction of the spring contact 87 in the present disclosure.

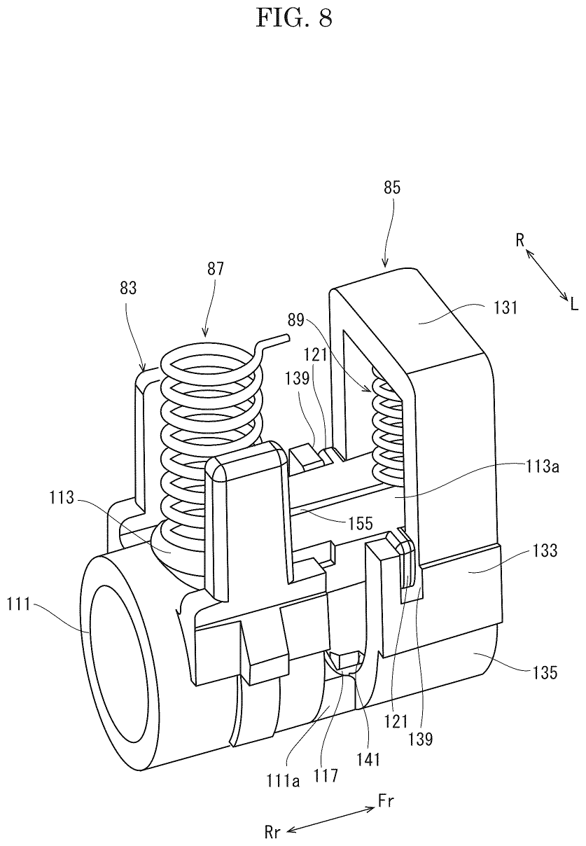

Next, the assembly of the fixed case 81, the conductive bushing 83, the intermediate case 85, the spring contact 87, and the auxiliary coil spring 89 into the rear bearing assembly 51R will be described with reference to FIG. 3, FIG. 4, and FIG. 8. FIG. 8 is a perspective view showing the assembled conductive bushing 83, the intermediate case 85, a part of the spring contact 87, and the auxiliary coil spring 89.

First, the conductive bushing 83 is assembled to the fixed case 81. The conductive bushing 83 is supported by the fixed case 81 movably in the upper-and-lower direction by inserting the engagement projections 125 formed on the side plate parts 115 into the openings 107 of the pair of leg parts 97 of the fixed case 81. More specifically, the side plate parts 115 of the conductive bushing 83 are fitted between the pair of leg parts 97 from below the fixed case 81. Then, the inclined upper surfaces of the engagement projections 125 of the conductive bushing 83 abut against the pair of leg parts 97. When the conductive bushings 83 are further fitted, the pair of leg parts 97 are pushed outwardly by the upper surfaces of the engagement projections 125 to be elastically deformed. When the engagement projections 125 are inserted into the openings 107, the pair of leg parts 97 elastically returns. As a result, the conductive bushing 83 is coupled to the fixed case 81.

Then, the deflection part 151 of the spring contact 87 is compressed, and engaged with the projection 99 of the top plate part 91 of the fixed case 81 and the projection 119 of the top plate part 113 of the conductive bushing 83 (see FIG. 3). The fixed end part 153 of the spring contact 87 is pulled upward through the slit 105 of the front plate part 93 of the fixed case 82 (see FIG. 4). The free end part 155 of the spring contact 87 is disposed along the top plate extension portion 113a of the conductive bushing 83 and engaged with the engagement projections 123 on the top surface of the top plate extension portion 113a.

Thereafter, the intermediate case 85 is assembled to the conductive bushing 83. As shown in FIG. 9, the top plate extension portion 113a of the conductive bushing 83 is inserted into the opening of the intermediate case 85, the pair of guide projections 121 of the top plate extension portion 113a are engaged with the guide grooves 139 of the side plate parts 133 of the intermediate case 85, and the guide pin 117 of the bearing extension portion 111a of the conductive bushing 83 is engaged with the guide groove 141 of the bottom plate part 135. Thus, the intermediate case 85 is engaged with the conductive bushing 73 movably in the upper-and-lower direction.

Thereafter, the auxiliary coil spring 89 is compressed and disposed between the top plate part 131 of the intermediate case 85 and the top plate extension portion 113a of the conductive bushing 83. At this time, the end portion of the free end part 155 of the spring contact 87 is held between the auxiliary coil spring 89 and the top plate extension portion 113a of the conductive bushing 83. Thus, the rear bearing assembly 51R is assembled.

Next, a method of supporting the front and rear end portions of the rotational shaft 61 of the primary transfer roller 33 by the front and rear rails 29F and 29R via the front and rear bearing assemblies 51F and 51R will be described. As shown in FIG. 3, the front end portion of the rotational shaft 61 is inserted into the conductive bushing 73 of the front bearing assembly 51F. Thus, the front end portion is rotatably supported by the conductive bushing 73.

As shown in FIG. 3, the rear end portion of the rotational shaft 61 is rotatably supported by the conductive bushing 83 which is coupled to the fixed case 81 of the rear bearing assembly 51R. As shown in FIG. 4, the rear bearing assembly 51R is positioned such that the front plate part 93 of the fixed case 81 faces inward (forward). The rear end portion passes between the bottom plate part 135 of the intermediate case 85 and the top plate extension portion 113a of the conductive bushing 83 and is inserted into the bearing part 111 of the conductive bushing 83. Thus, the rear end portion is rotatably supported by the conductive bushing 83.

Further, the rear end portion is electrically connected to the spring contact 87 via the conductive bushing 83. More specifically, as shown in FIG. 3 and FIG. 4, the contact between the deflection part 151 of the spring contact 87 and the conductive bushing 83 and the contact between the free end part 155 of the spring contact 87 and the conductive bushing 83 electrically connect the spring contact 87 and the conductive bushing 83, and electrically connect the spring contact 87 and the rotational shaft 61 via the conductive bushing 83.

As shown in FIG. 2, the front and rear bearing assemblies 51F and 51R into which the front and rear end portions of the rotational shaft 61 are inserted are supported by the front and rear rails 29F and 29R. More specifically, the rail is held between the upper and lower ribs 101 and 103 of the front plate part 93 of the fixed case 81. As a result, the fixed cases 81 of the front and rear bearing assemblies 51F and 51R are suspended from the front and rear rails 29F and 29R, and the primary transfer roller 33 is in contact with the inner peripheral surface of the intermediate transfer belt 31 in the primary transfer nip.

Further, when the intermediate transfer unit 29 is attached to the apparatus main body 3, the fixed end part 153 of the spring contact 87 is electrically connected to a fixed contact (not shown) connected to the transfer bias power supply. This allows the voltage supplied from the transfer bias power supply to be applied from the fixed contact to the rotational shaft 61 of the primary transfer roller 33 via the spring contact 87 and the conductive bushing 83. When the transfer bias is applied to the primary transfer roller 33, the toner image on the photoconductive drum 19 is transferred to the intermediate transfer belt 31.

The load applied to the primary transfer roller 33 in the rear bearing assembly 51R having the above configuration will be described with reference to FIG. 9. FIG. 9 is a cross-sectional perspective view showing the rear bearing assembly 51R.

As shown in FIG. 9, a downward load F1 is applied to the top plate part 113 of the conductive bushing 83 from the deflection part 151 of the spring contact 87. When a spring load of the deflection part 151 is 0.9 N, the load F1 applied from the deflection part 151 to the top plate part 91 of the conductive bushing 83 is 0.9 N. A downward load F2 is also applied from the auxiliary coil spring 89 to the top plate extension portion 113a of the conductive bushing 83. When a spring load of the auxiliary coil spring 89 is 2.5 N, the load F3 applied from the auxiliary coil spring 89 to the top plate part 131 of the intermediate case 86 is 2.5 N, and the load F2 applied to the top plate extension portion 113a of the conductive bushing 83 is 2.5 N.

The deflection part 151 and the auxiliary coil spring 89 are disposed at different positions, but since the directions of the loads applied to the conductive bushing 83 from the deflection part 151 and the auxiliary coil spring 89 are the same direction(downward), the downward load F4 applied to the rotational shaft 61 from the deflection part 151 and the auxiliary coil spring 89 via the conductive bushing 83 is 0.9+2.5=3.4 N.

On the other hand, an upward load F5 applied to the rotational shaft 61 from the bottom plate part 135 of the intermediate case 85 is 2.5 N. Thus, a downward load F6 applied to the rotational shaft 61 is 0.9 N obtained by subtracting the upward load 2.5 N from the downward load 3.4 N applied from the deflection part 151 and the auxiliary coil spring 89. In other words, the downward load F6 (reaction force of the intermediate transfer belt 31) applied from the rotational shaft 61 to the intermediate transfer belt 31 is 0.9 N.

In general, when a high-voltage power source (about 1000 V in one example) such as a transfer bias is applied, the load of the spring contact is preferably 2.0 N or more for safety reasons. In this embodiment, the spring load of the deflection part 151 of the spring contact 87 is 0.9 N, which is a relatively low value, but since the spring load from the auxiliary coil spring 89 is applied, the load of 3.4 N can be applied from the conductive bushing 83 to the rotational shaft 61. On the other hand, since the spring load of the auxiliary coil spring 89 is not applied to the intermediate transfer belt 31, substantially only the load of the spring contact 87 is applied to the intermediate transfer belt 31. As described above, in the case where it is preferable to set the load applied to the intermediate transfer belt 31 to a relatively low value (for example, 2.0 N or less) depending on the materials of the primary transfer roller 33, the intermediate transfer belt 31, and the photoconductive drum 19, the load applied to the deflection part 151 of the spring contact 87 can be reduced.

As described above, the image forming apparatus 1 of the present disclosure is provided with the auxiliary coil spring 89 which applies the load to the conductive bushing 83 from a direction parallel to the direction of the load applied to the conductive bushing 83 from the spring contact 87, so that the load applied to the conductive bushing 83 can be increased. Therefore, even when the load applied from the spring contact 87 to the conductive bushing 83 is small, the insufficient load can be compensated and the conduction failure of the spring contact 87 can be suppressed.

For example, depending on the material of the intermediate transfer belt 31, it may be desired to reduce the load applied from the primary transfer roller 33 to the intermediate transfer belt 31. In such a case, if the load of the spring contact 87 is reduced, the conduction of the spring contact 87 becomes unstable, which is undesirable from the viewpoint of safety. Therefore, by providing the auxiliary coil spring 89, the load applied to the intermediate transfer belt 31 can be set to a relatively low value while applying a proper load from the conductive bushing 83 to the rotational shaft 61. In this way, the safety of the spring contact 87 and the primary transfer performance can be compatible.

Further, the spring contact 87 is into contact with the conductive bushing 83 via the deflection part 151 and the free end part 155. Further, the distal end portion of the free end part 155 is pressed against the conductive bushing 83 by the auxiliary coil spring 89. Therefore, the spring contact 87 and the conductive bushing 83 can be securely electrically connected.

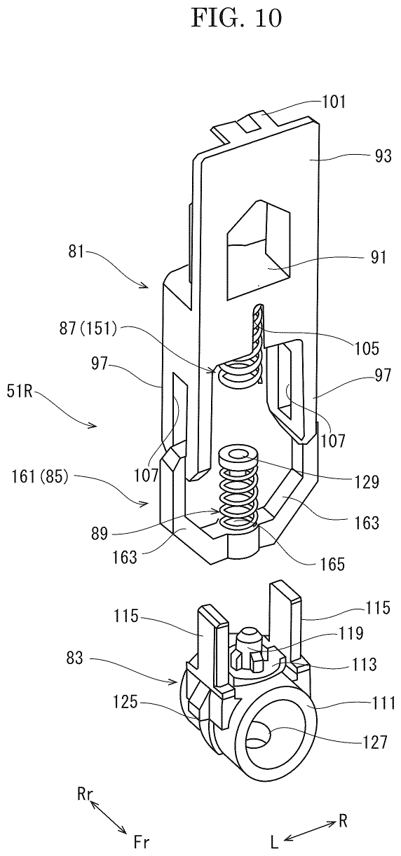

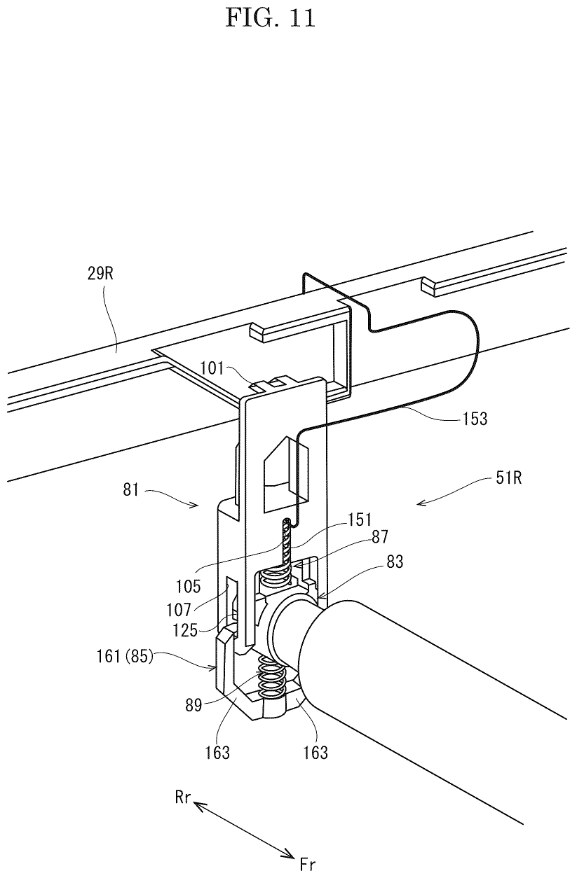

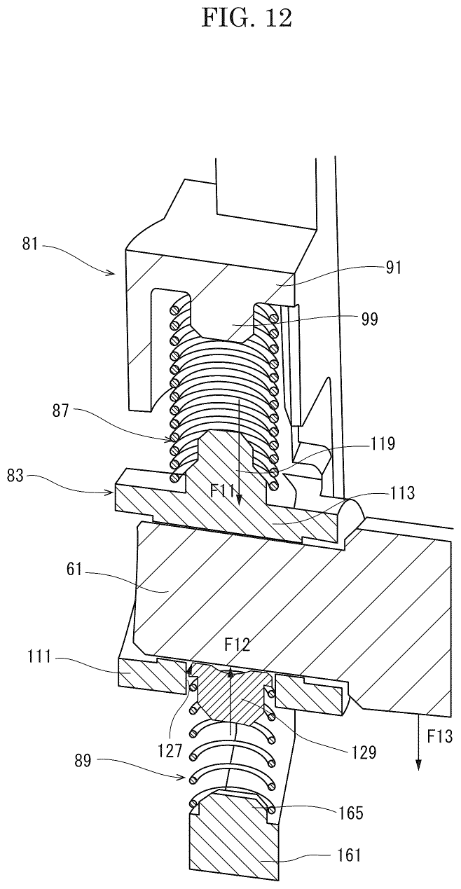

Next, a modified example of the rear bearing assembly 51R will be described with reference to FIG. 10 to FIG. 12. FIG. 10 is a disassembled perspective view showing the rear bearing assembly 51R, FIG. 11 is a perspective view showing the rear bearing assembly 51R, and FIG. 12 is a cross-sectional perspective view showing the rear bearing assembly 51R. The rear bearing assembly 51R includes the fixed case 81, the conductive bushing 83, the intermediate case 85, the spring contact 87, and the auxiliary coil spring 89. The fixed case 81 has the same structure as the fixed case 81 of the above-described embodiment.

First, the conductive bushing 83 will be described. In the modified example, the intermediate case 85 for housing the auxiliary coil spring 89 of the above-described embodiment is provided in the fixed case 81 as a spring support member 161. As shown in FIG. 10, the conductive bushing 83 includes a bearing part 111, a top plate part 113, and a pair of side plate parts 115. The bearing part 111 and the top plate part 113 do not include the bearing extension portion 111a and the top plate extension portion 113a of the above-described embodiment. Further, a through-hole 127 penetrating in the upper-and-lower direction is formed at the bottom portion of the bearing part 111. The through-hole 127 is aligned with the projection 119 formed on the top plate part 113 in the upper-and-lower direction.

The spring support member 161 extends downward from the pair of leg parts 97 of the fixed case 81, has a frame-like shape surrounding the conductive bushing 83, and penetrates in the same direction as the axial hole of the bearing part 111. In the embodiment shown in FIG. 10 and FIG. 11, the spring support member 161 has a U-shape with a pair of arm portions 163. A hook is formed at the distal end of the arm portion 163. By engaging the hooks with the openings 107 of the pair of leg parts 97, the spring support member 161 is attached to the fixed case 81. A projection 165 is formed on the bottom surface of the spring support member 161. The projection 165 is aligned with the through-hole 127 of the bottom portion of the bearing part 111 in the upper-and-lower direction. Further, the spring support member 161 may be integrally formed with the fixed case 81 by extending the pair of leg parts 97 downward and connecting the distal ends of the pair of leg parts 97 to each other.

Next, the spring contact 87 will be described. As shown in FIG. 11, the spring contact 87 has the coiled deflection part 151 and the fixed end part 153 extending from one end of the deflection part 151. The deflection part 151 is disposed in a compressed manner between the projection 99 of the top plate part 91 of the fixed case 81 and the projection 119 of the top plate part 113 of the conductive bushing 83. The fixed end part 153 is pulled out upward through the slit 105 of the front plate part 93 of the fixed case 81.

Next, the auxiliary coil spring 89 will be described. As shown in FIG. 10, the lower end of the auxiliary coil spring 89 is fitted around the projection 165 of the spring support member 161. A movable body 129 is fixed to the upper end of the auxiliary coil spring 89. The movable body 129 is inserted into the through-hole 127 of the bearing part 111 of the conductive bushing 83.

When the rear end portion of the rotational shaft 61 of the primary transfer roller 33 is inserted into the bearing part 111 of the conductive bushing 83, the rear end portion of the rotational shaft 61 is pushed upward by the auxiliary coil spring 89 through the movable body 129.

Next, a load applied to the primary transfer roller 33 will be described with reference to FIG. 12. When a spring load of the deflection part 151 of the spring contact 87 is 3.4 N, a load F11 applied from the deflection part 151 to the top plate part 113 of the conductive bushing 83 is 3.4 N. When a spring load of the auxiliary coil spring 89 is 2.5 N, a load F12 applied from the auxiliary coil spring 89 to the rotational shaft 61 is 2.5 N. The direction of the force applied from the deflection part 151 is opposite to the direction of the force applied from the auxiliary coil spring 89. As a result, the force applied from the deflection part 151 and the force applied from the auxiliary coil spring 89 cancel each other, and the load F13 applied from the rotational shaft 61 to the intermediate transfer belt 31 becomes 3.4−2.5=0.9 N.

In this example, the load applied to the conductive bushing 83 from the deflection part 151 is 3.4 N, and the conduction failure of the spring contact 87 can be reliably prevented. On the other hand, in the case where such a high load is not preferably applied to the intermediate transfer belt 31, the load F12 is applied to the conductive bushing 83 from the direction opposite to the direction of the load F11 applied to the conductive bushing 83 from the deflection part 151. That is, an upward force is applied from the auxiliary coil spring 89 to the conductive bushing 83. As a result, since the force applied from the deflection part 151 and the force applied from the auxiliary coil spring 89 cancel each other, the load applied from the rotational shaft 61 to the intermediate transfer belt 31 can be reduced.

Further, in this example, since the spring support member 161 is formed in the fixed case 81, the dimension in the axial direction of the rotational shaft 61 can be reduced. In addition, there is an advantage that the number of parts can be reduced by forming the spring support member 161 integrally with the fixed case 81.

Although the disclosure has been described with respect to certain embodiments, the disclosure is not limited to the foregoing embodiments. The above embodiments can be modified by those skilled in the art without departing from the scope and spirit of the disclosure.

### Appendix 1

An image forming apparatus according to Appendix 1 includes:
a primary transfer roller to which a transfer bias for transferring a toner image from a photoconductive drum to an intermediate transfer belt is applied;
a conductive bushing by which an end portion of the primary transfer roller is supported;
a spring contact which is electrically connected to the primary transfer roller via the conductive bushing;
a fixed case which houses the conductive bushing and the spring contact; and
an elastic member which applies a load to the primary transfer roller from a direction parallel to a load direction of the spring contact.

### Appendix 2

The image forming apparatus according to appendix 2 is the image forming apparatus according to Appendix 1, and includes:
an intermediate case supported by the conductive busing, wherein
the elastic member is housed in the intermediate case and applies a load to the primary transfer roller from the same direction as the load direction at a position different from the spring contact in an axial direction of the primary transfer roller.

### Appendix 3

The image forming apparatus according to Appendix 3 is the image forming apparatus according to Appendix 2, wherein
the intermediate case is supported by the conductive bushing adjacent to the fixed case in the axial direction of the primary transfer roller.

### Appendix 4

The image forming apparatus according to Appendix 4 is the image forming apparatus according to Appendix 2 or 3, wherein
the spring contact has a deflection part and a free end part extending from the deflection part,
the deflection part is housed in the fixed case, and the free end part is pressed against the conductive bushing or the end portion of the primary transfer roller by the elastic member.

### Appendix 5

The image forming apparatus according to Appendix 5 is the image forming apparatus according to Appendix 1, wherein
the elastic member applies a load to the primary transfer roller from a direction opposite to the load direction.

### Appendix 6

The image forming apparatus according to Appendix 6 is the image forming apparatus according to Appendix 5, wherein
the elastic member is provided between a spring support member formed in the fixed case and the conductive bushing.

### Appendix 7

The image forming apparatus according to Appendix 7 is the image forming apparatus according to Appendix 5 or 6, wherein
the elastic member applies a load to the primary transfer roller from an opposite direction to the load direction at the same position as the spring contact in an axial direction of the primary transfer roller.

### Appendix 8

The image forming apparatus according to Appendix 8 is the image forming apparatus according to any one of Appendixes 1 to 7, wherein
the elastic member is a coil spring.

What is claimed is:

1. An image forming apparatus comprising:
a primary transfer roller to which a transfer bias for transferring a toner image from a photoconductive drum to an intermediate transfer belt is applied;
a conductive bushing by which an end portion of the primary transfer roller is supported;
a spring contact which is electrically connected to the primary transfer roller via the conductive bushing;
a fixed case which houses the conductive bushing and the spring contact; and
an elastic member which applies a load to the primary transfer roller from a direction parallel to a load direction of the spring contact.

2. The image forming apparatus according to claim 1, comprising:
an intermediate case supported by the conductive busing, wherein
the elastic member is housed in the intermediate case and applies a load to the primary transfer roller from the same direction as the load direction at a position different from the spring contact in an axial direction of the primary transfer roller.

3. The image forming apparatus according to claim 2, wherein
the intermediate case is supported by the conductive bushing adjacent to the fixed case in the axial direction of the primary transfer roller.

4. The image forming apparatus according to claim 2, wherein
the spring contact has a deflection part and a free end part extending from the deflection part,
the deflection part is housed in the fixed case, and the free end part is pressed against the conductive bushing or the end portion of the primary transfer roller by the elastic member.

5. The image forming apparatus according to claim 1, wherein
the elastic member applies a load to the primary transfer roller from a direction opposite to the load direction.

6. The image forming apparatus according to claim 5, wherein
the elastic member is provided between a spring support member formed in the fixed case and the conductive bushing.

7. The image forming apparatus according to claim 5, wherein
the elastic member applies a load to the primary transfer roller from an opposite direction to the load direction at the same position as the spring contact in an axial direction of the primary transfer roller.

8. The image forming apparatus according to claim 1, wherein
the elastic member is a coil spring.
